(19) United States
(12) Patent Application Publication
(10) Pub. No.: US 2011/0029792 A1
(43) Pub. Date: Feb. 3, 2011

(54) INFORMATION PROCESSING APPARATUS AND POWER SUPPLYING CONTROL METHOD

(75) Inventor: Masanori Nakano, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/828,101

(22) Filed: Jun. 30, 2010

(30) Foreign Application Priority Data
Jul. 31, 2009 (JP) 2009-179515

(51) Int. Cl. G06F 1/00

(52) U.S. Cl. 713/300

(57) ABSTRACT

According to one embodiment, an information processing apparatus which supplies power to a communication partner device, includes: a communication module which performs communication with the communication partner device; a power supplying module which supplies power to the communication partner device using a power supply for driving the information processing apparatus; a power supplying determination module which determines whether the power supplying module supply power or not; and a device identification module which determines whether the communication partner device has a function to be charged by the power supplying module. The power supplying determination module drives the power supplying module using the power supply when the device identification module determines that the communication partner device has a to-be-charged function, while the power supplying determination module does not drive the power supplying module when the device identification module determines that the communication partner device does not have the to-be-charged function.

### CROSS REFERENCE TO RELATED APPLICATION(S)

The present disclosure relates to the subject matters contained in Japanese Patent Application No. 2009-179515 filed on Jul. 31, 2009, which are incorporated herein by reference in its entirety.

### BACKGROUND

1. Field

The present invention relates to an information processing apparatus and a power supplying control method.

2. Description of the Related Art

In recent years, there are various mobile devices which can be used portably. For example, cellular phones which are familiar mobile devices have not only a verbal communication function and a photographing function but also a communication function capable of connecting to the Internet.

In addition, mobile devices such as Personal Digital Assistants (PDA) or Mobile Internet Devices (MID) are also being developed.

Although available storage capacities of mobile devices have increased from year to year, the storage capacities are however limited. For this reason, when data are accumulated to a certain extent in a mobile device, the data must be backed up in another personal computer or hard disk than the mobile device so as to secure a free storage space in the mobile device. Since it takes time to move the data, the mobile device can be charged in parallel with the data movement when the mobile device is connected to the personal computer in order to back up the data. In this manner, the driving time of the mobile device can be extended.

For example, JP-A-2008-306704 discloses a method in which charging and communication are performed in a non-contact manner between a mobile device and a cradle connected to a personal computer.

However, JP-A-2008-306704 only suggests using different frequency bands to prevent a charging process and a communication process from affecting each other. That is, power always supplied to the cradle simply to keep the cradle in a chargeable state may lead to wasteful power consumption.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 is an exemplary external view of a personal computer according to an embodiment of the invention;

FIG. 2 is an exemplary functional block diagram of the personal computer according to the embodiment;

FIG. 3 is an exemplary conceptual diagram of a storage state of a database about devices each having a to-be-charged function according to the embodiment;

FIG. 4 is an exemplary functional block diagram of a power supplying module of the personal computer according to the embodiment;

FIG. 5 is a first exemplary flow chart showing a procedure of power supplying operation of the personal computer according to the embodiment; and

FIG. 6 is a second exemplary flow chart showing another procedure of power supplying operation of the personal computer according to the embodiment.

### DETAILED DESCRIPTION

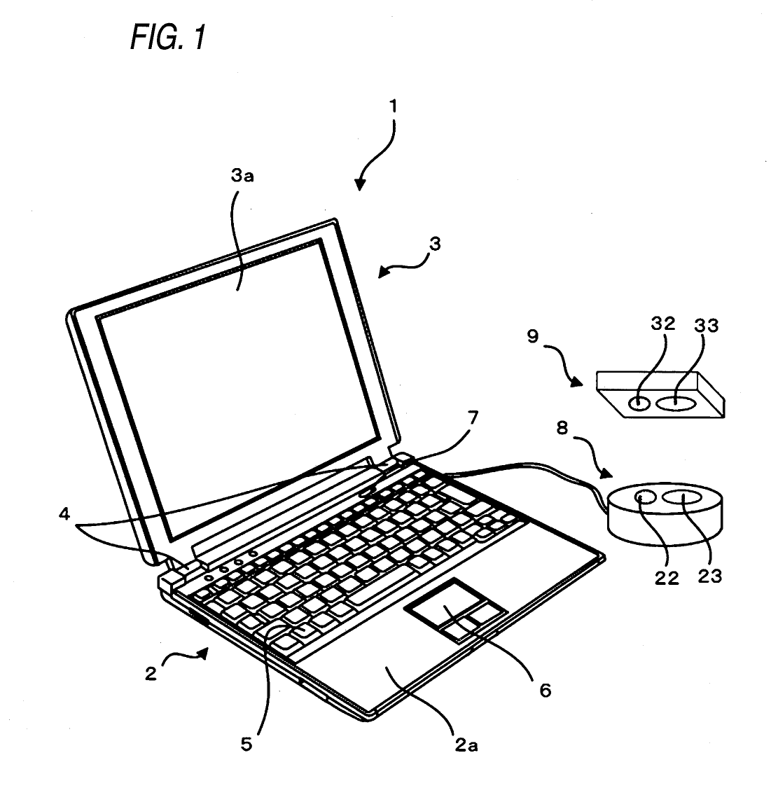

An embodiment of the invention will be described below with reference to FIGS. 1 to 6.

As an information processing apparatus according to the embodiment, a personal computer 1 will be described by way of example. First, the structure of the personal computer 1 will be described with reference to FIG. 1. FIG. 1 is an exemplary perspective view of the external appearance of the personal computer 1 according to the embodiment.

In the personal computer 1, a body unit 2 and a display unit 3 are provided so that the display unit 3 can rotate with respect to the body unit 2 around hinges 4. The body unit 2 includes a body housing 2a, a keyboard 5, a touch pad 6 and a power switch 7. A display device 3a is provided at a center of the display unit 3. In the embodiment, upper, lower, near, far, right and left are defined as upper, lower, near, far, right and left sides viewed from a user who uses the personal computer 1 while facing the display device 3a.

The display device 3a displays video images based on a video signal sent out from a graphic chip mounted on a board. The display device 3a is, for example, a Liquid Crystal Display (LCD) or the like.

Operating devices such as the keyboard 5, the touch pad 6 are provided on a top surface of the body housing 2a, and the body housing 2a internally houses the board, a Hard Disk Drive (HDD) 16, etc. In addition, Universal Serial Bus (USB) connectors are provided in a right side surface of the body housing 2a so as to enable connection to various external devices.

The keyboard 5 is an input device provided on the top surface of the body housing 2a. Buttons of the keyboard 5 are operated so that operating signals for inputting characters or selecting icons or the like can be transmitted to respective members.

The touch pad 6 is a pointing device provided on the top surface of the body housing 2a. The touch pad 6 is operated so that operating signals for moving a cursor on the screen or selecting icons or the like can be transmitted to an EC/KBC 18.

The power switch 7 inputs a control signal to power on/off the personal computer 1 in accordance with user's operation.

A power supplying unit 8 is connected to the body unit 2 through a USB or the like according to the embodiment. The power supplying unit 8 includes a first communication portion 22 and a first power supplying module 23. The power supplying unit 8 may be built in the personal computer 1. The first communication portion 22 is a module for performing wireless communication with an external device. The first communication portion 22 includes a wireless antenna, a wireless communication circuit, etc. The first power supplying module 23 executes a power supplying process upon a communication partner device 9 by electromagnetic induction or the like after authentication between the devices, for example, between the personal computer 1 and the communication partner device 9, is completed in the first communication portion 22. The function of the first power supplying module 23 will be described later. Different frequency bands are used for the first communication portion 22 and the first power supplying module 23 to prevent the power supplying process and the wireless communication from affecting each other.

The first communication portion 22 is designed to be able to perform at least two kinds of wireless communications. According to the embodiment, the first communication portion 22 includes a first communication module 22a for performing authentication between devices and a second communication module 22b for performing data transmission and reception. For example, assume that a non-contact IC card technique is used for the communication for authentication between devices, a short-range wireless communication technique is used for the communication for data transmission and reception (video and audio data, etc.), and the two communications can be switched. For example, the communication based on the non-contact IC card technique is carried out for authentication between devices, and after the authentication is completed, the communication is switched to the communication based on the short-range wireless communication technique.

The non-contact IC card technique uses electromagnetic induction, requiring no electric power to start communication. That is, when the communication partner device 9 is brought close to a magnetic field generated from the first communication module 22a of the power supplying unit 8, an electric current flows into a coil type antenna built in a third communication module 32a of the communication partner device 9 so that the communication partner device 9 can be started up. Based on the non-contact IC card technique, the communication partner device 9 is authenticated so that power supplying is started. Thus, authentication can be executed and power supplying can be performed even when the communication partner device 9 has not been charged at all. After power supplying is started and power is supplied to the communication partner device 9, the wireless communication is switched from the communication based on the non-contact IC card technique to the communication based on the short-range wireless communication technique so that higher speed data transmission/reception can be carried out.

The communication partner device 9 includes a second communication portion 32 and a second power supplying module 33 corresponding to the power supplying unit 8, respectively. The second communication portion 32 carries out authentication between the devices and transmits/receives data to/from the first communication portion 22 of the power supplying unit 8 by wireless communication. Specifically, the second communication portion 32 includes the third communication module 32a for communicating with the first communication module 22a for authentication between the devices, and a fourth communication module 32b for communicating with the second communication module 22b for data transmission/reception. The second power supplying module 33 charges power supplied from the first power supplying module 23 of the power supplying unit 8. In addition, the second power supplying module 33 has a memory 33a for storing a charge state of the communication partner device 9.

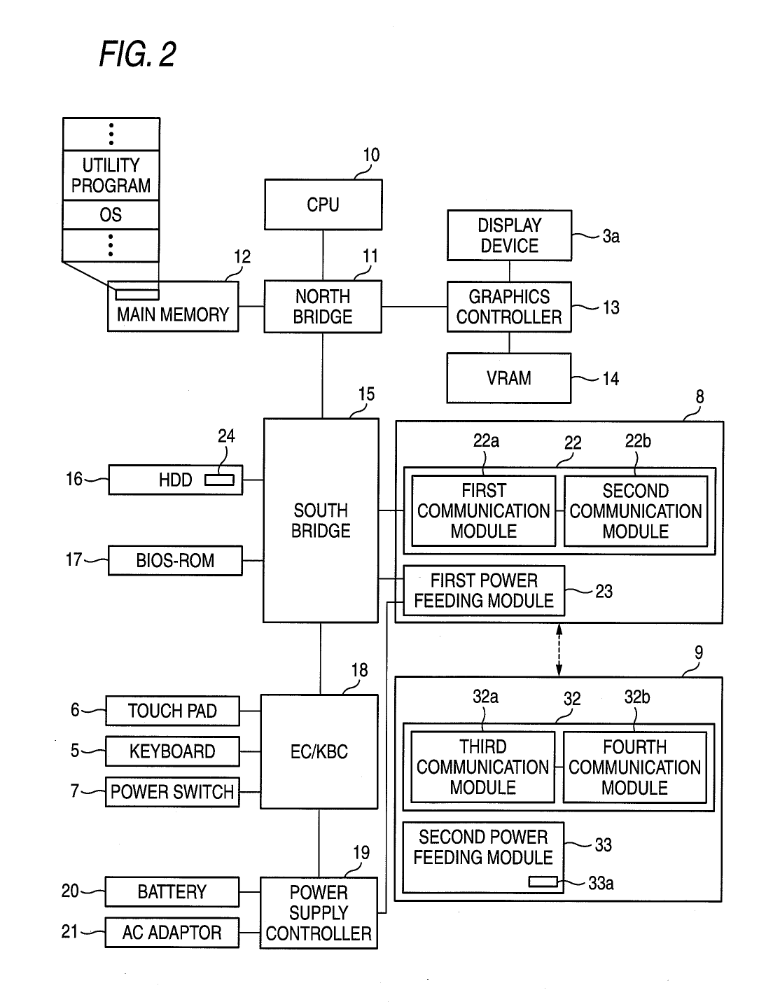

Next, functions of the personal computer 1 will be described with reference to FIG. 2. FIG. 2 is an exemplary functional block diagram of the personal computer 1 according to the embodiment.

The personal computer 1 includes the keyboard 5, the touch pad 6, the power switch 7, a CPU 10, a north bridge 11, a main memory 12, a graphics controller 13, a VRAM 14, a south bridge 15, the HDD 16, a BIOS-ROM 17, the EC/KBC 18, a power supply controller 19, a battery 20, an AC adaptor 21, the first communication portion 22 and the first power supplying module 23.

The CPU 10 is a processor provided for controlling the operation of the personal computer 1. The CPU 10 executes an operating system and various application programs loaded from the HDD 16 to the main memory 12. The CPU 10 also executes a system BIOS stored in the BIOS-ROM 17 after the system BIOS is loaded to the main memory 12. The system BIOS is a program for controlling the hardware.

The north bridge 11 is a bridge device for connecting a local bus of the CPU 10 with the south bridge 15. The north bridge 11 also includes a built-in memory controller for controlling access to the main memory 12. The north bridge 11 also has a function of executing communication with the graphics controller 13 through an Accelerated Graphics Port (AGP) bus or the like.

The main memory 12 is a so-called working memory for expanding the operating system and the various application programs stored in the HDD 16 and the system BIOS stored in the BIOS-ROM 17.

The graphics controller 13 is a display controller for controlling the display device 3a used as a display monitor of the personal computer 1. By the graphics controller 13, a video signal for forming a display image to be displayed on the display device 3a is generated from display data drawn in the VRAM 14 by the operating system/application programs.

The south bridge 15 controls access to the BIOS-ROM 17 and disk drives (I/O devices) such as the HDD 16, an Optical Disk Drive (ODD), etc. In addition, in the embodiment, the first communication portion 22 for performing wireless communication with an external device, and the first power supplying module 23 are connected to the south bridge 15. The south bridge 15 controls the first communication portion 22 and the first power supplying module 23.

The HDD 16 is a storage device for storing the operating system, the various application programs, etc. According to the embodiment, the HDD 16 also stores a wattage W1 of power which can be fed by the personal computer 1, and a database 24 where information about devices each having a to-be-charged function is listed. Although the embodiment will be described on the assumption that the database 24 is stored in the HDD 16, the database 24 may be stored in a memory or the like provided in the first power supplying module 23.

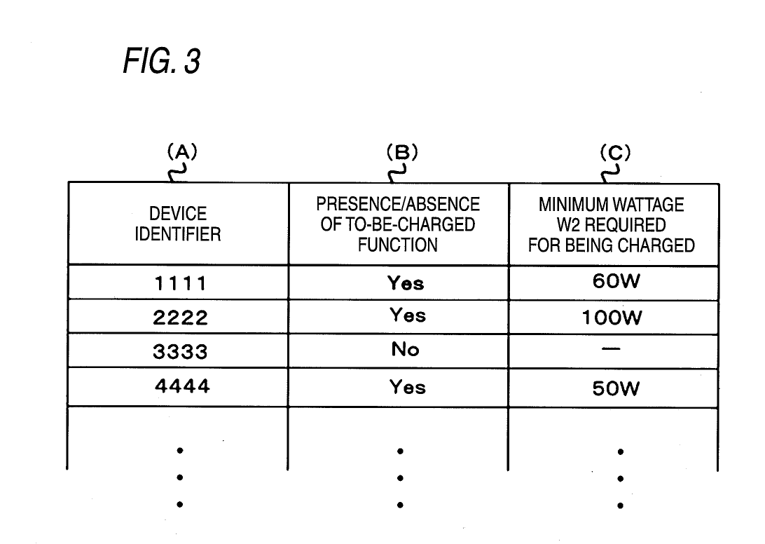

FIG. 3 is an exemplary conceptual diagram of the storage state of the database 24 about devices each having a to-be-charged function according to the embodiment. In the database 24, an identifier (A) of each device, presence/absence (B) of a to-be-charged function, and a minimum wattage W2 (C) required to be charged are listed. For any device having no to-be-charged function, the fact that power cannot be fed may be displayed on the display device 3a.

The BIOS-ROM 17 is a rewritable nonvolatile memory for storing the system BIOS which is a program for controlling the hardware.

The EC/KBC 18 controls the touch pad 6 and the keyboard 5 as input means.

The EC/KBC 18 is a one-chip microcomputer which monitors and controls various devices (peripheral devices, sensors, power supply circuits, etc.) regardless of the system status of the personal computer 1. The EC/KBC 18 also has a function of powering on/off the personal computer 1 in accordance with user's operation on the power switch 7 and in cooperation with the power supply controller 19.

When an external power is supplied through the AC adapter 21, the power supply controller 19 uses the external power supplied from the AC adapter 21 to generate a system power to be supplied to each component of the personal computer 1. When no external power is supplied through the AC adapter 21, the power supply controller 19 uses the battery 20 to generate a system power to be supplied to each component of the personal computer 1. In addition, when power is supplied from the first power supplying module 23 to the communication partner device 9 through wireless communication in the first communication portion 22, the power supply controller 19 makes control to supply power to the first power supplying module 23.

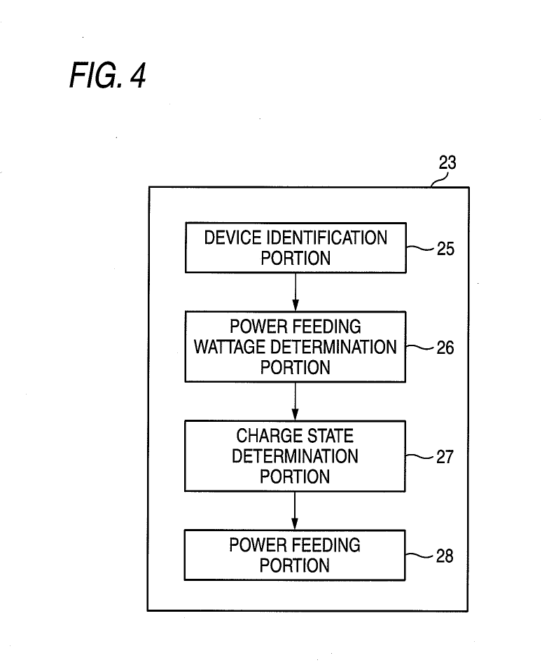

Next, the function of the first power supplying module 23 will be described with reference to FIG. 4. FIG. 4 is an exemplary functional block diagram of the power supplying module 23 of the personal computer 1 according to the embodiment. The first power supplying module 23 includes a device identification portion 25, a power supplying wattage determination portion 26, a charge state determination portion 27 and a power supplying portion 28. These portions perform determination in turn using a device identifier or the like acquired from the communication partner device 9. Functions of these functional blocks will be described in turn as follows. The power supplying wattage determination portion 26 and the charge state determination portion 27 correspond to a power supplying determination portion.

The device identification portion 25 identifies the communication partner device 9 by wireless communication performed by the first communication module 22a. A unique identifier is acquired from the communication partner device 9, and collated with the database 24 stored in the HDD 16 so as to identify the communication partner device 9. That is, when the communication partner device 9 coincides with one of the devices stored in the database 24, a wattage is determined in the power supplying wattage determination portion 26. When the communication partner device 9 does not coincide with any one of the devices stored in the database 24, the power supplying process is not carried out.

The power supplying wattage determination portion 26 compares a wattage W1 stored in the HDD 16 with a minimum wattage W2 required for charging the communication partner device 9. The wattage W1 designates a wattage allowed to be fed by the personal computer 1. That is, when the minimum wattage W2 required for charging the communication partner device 9 is not higher than the wattage W1 allowed to be fed by the personal computer 1, further determination is performed in the charge state determination portion 27. When the minimum wattage W2 is higher than the wattage W1, the power supplying process is not carried out.

The charge state determination portion 27 reads out the charge state of the communication partner device 9 stored in the second power supplying module 33, and determines whether the charge state of the communication partner device 9 is a full charge state or not. When determination results in that the state is not a full charge state, the procedure moves to the power supplying portion 28. When determination results in that the state is a full charge state, the power supplying process is not carried out.

The power supplying portion 28 executes the power supplying process upon the second power supplying module 33 of the communication partner device 9 by electromagnetic induction or the like. Power required for supplying power is supplied from the battery 20 or the AC adaptor 21.

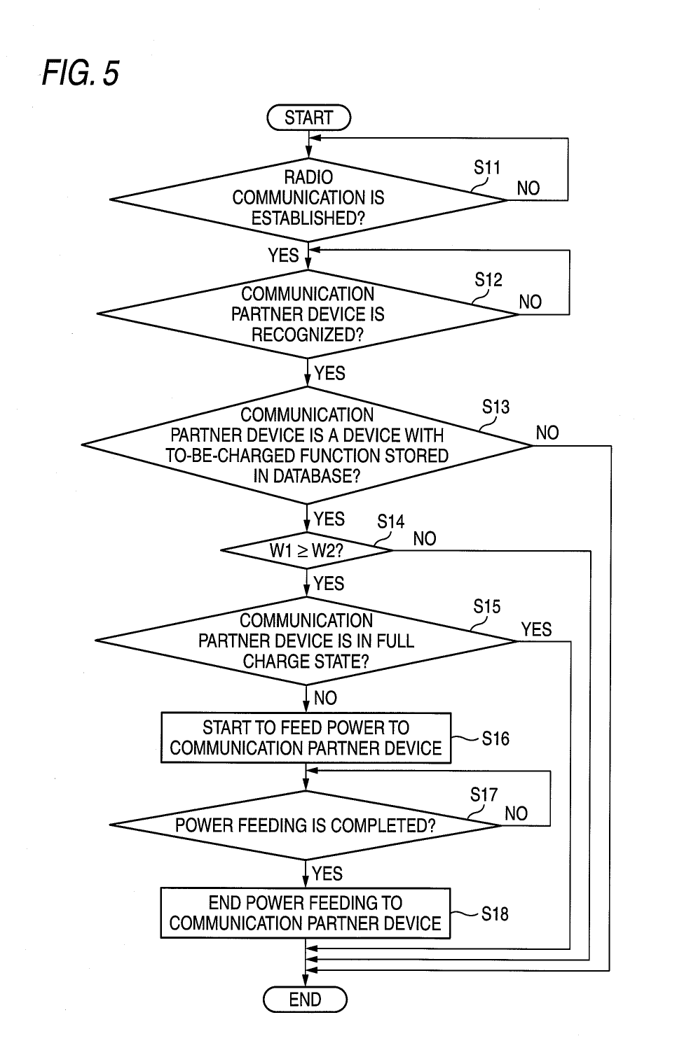

Next, a first example of the power supplying process implemented by the functions of the aforementioned functional blocks will be described with reference to FIG. 5. FIG. 5 is a first exemplary flow chart showing a procedure of the power supplying operation of the personal computer 1 according to the embodiment.

First, the first communication module 22a determines whether wireless communication with the communication partner device 9 is established or not (Step S11). That is, after a communication start request is transmitted to the third communication module 32 of the communication partner device 9, the first communication module 22a determines whether a response signal indicating acceptance of the communication start request is received from the third communication module 32 or not. When the response signal is received from the third communication module 32, the first communication module 22a determines that wireless communication is established.

When determination results in that wireless communication is not established (No in Step S11), Step S11 is repeated continuously till determination results in that wireless communication is established. On the contrary, when determination results in that wireless communication is established (Yes in Step S11), the device identification portion 25 then determines whether the communication partner portion 9 is recognized by communication in the first communication module 22a or not (Step S12). That is, the device identification portion 25 determines whether a unique identifier to each device is acquired from the communication partner device 9 or not.

When determination results in that the communication partner device 9 is not recognized (No in Step S12), Step S12 is repeated continuously till the communication partner device 9 is recognized. On the contrary, when determination results in that the communication partner device 9 is recognized (Yes in Step S12), the device identification portion 25 then determines whether the communication partner device 9 is a device with a to-be-charged function stored in the database 24 or not (Step S13). That is, the device identification portion 25 compares the acquired identifier with each device identifier (A) stored in the database 24 so as to detect the presence/absence (B) of the to-be-charged function of the communication partner device 9.

When determination results in that the communication partner device 9 is not a device with a to-be-charged function (No in Step S13), the procedure is ended. On the contrary, when determination results in that the communication partner device 9 is a device with a to-be-charged function (Yes in Step S13), the power supplying wattage determination portion 26 then determines whether or not the minimum wattage W2 required for charging the communication partner device 9 is not higher than the wattage W1 allowed to be fed by the personal computer 1 (Step S14). That is, the power supplying wattage determination portion 26 makes determination by comparison between the minimum wattage W2 (C) required for charging the communication partner device 9 and the wattage W1 allowed to be fed by the personal computer 1. The wattage W2 (C) is stored in the database 24, and the wattage W1 is stored in the HDD 16.

When determination results in that the minimum wattage W2 required for charging the communication partner device 9 is higher than the wattage W1 allowed to be fed by the personal computer 1 (No in Step S14), the procedure is ended. On the contrary, when determination results in that the minimum wattage W2 required for charging the communication partner device 9 is not higher than the wattage W1 allowed to be fed by the personal computer 1 (Yes in Step S14), the charge state determination portion 27 then determines whether the communication partner device 9 is in a full charge state or not (Step S15).

When determination results in that the communication partner device 9 is in a full charge state (Yes in Step S15), the procedure is ended. On the contrary, when determination results in that the communication partner device 9 is not in a full charge state (No in Step S15), the power supplying portion 28 is driven by use of a power supply for driving the personal computer 1. That is, power is supplied to the power supplying portion 28 from the personal computer 1 after completion of the determination as to the to-be-charged function of the communication partner device 9. Thus, power is not always supplied to the power supplying portion 28, so that wasteful power consumption can be suppressed.

Next, power supplying to the second power supplying module 33 of the communication partner device 9 is started in the power supplying portion 28 (Step S16). Then, the power supplying portion 28 determines whether power supplying to the communication partner device 9 is completed or not (Step S17). When determination results in that power supplying is not completed (No in Step S17), power supplying is kept on till determination results in that power supplying is completed. On the contrary, when determination results in that power supplying is completed (Yes in Step S17), the power supplying portion 28 stops power supplying to the communication partner device 9 (Step S18). Then, the procedure is ended.

According to the first example configured thus, whether power supplying to the communication partner device 9 is required or not is determined through wireless communication, so that the power supplying operation can be controlled. That is, since power to be fed does not have to be always supplied from the battery 20 or the AC adaptor 21 to the first power supplying module 23, power saving can be attained.

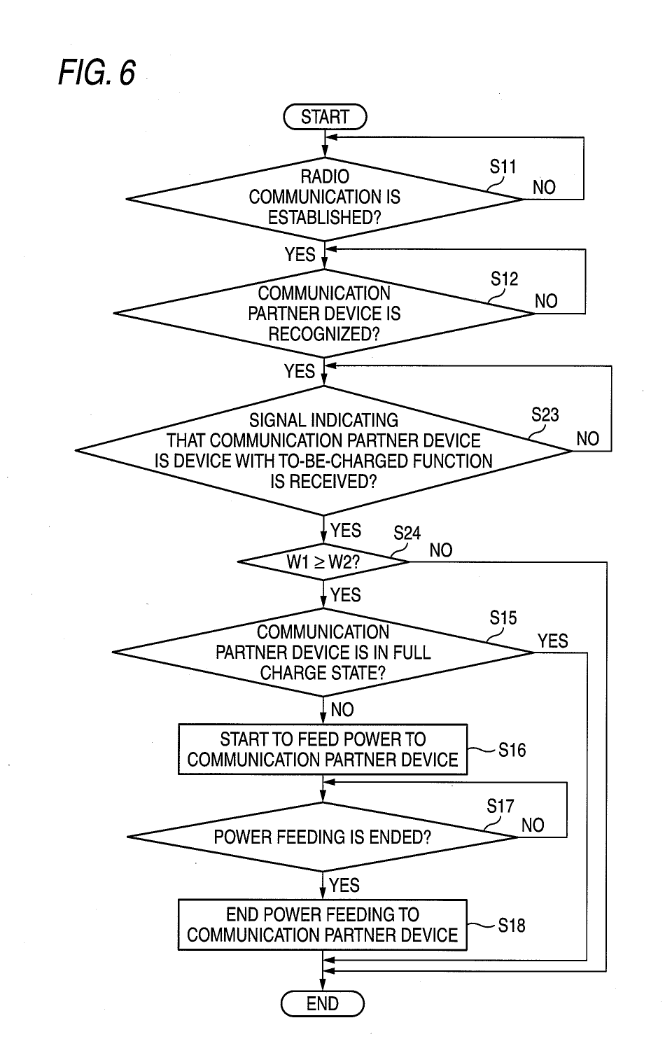

Next, a second example of the power supplying operation according to the embodiment will be described with reference to FIG. 6. In the second example, the communication partner device 9 has a function of sending out a signal about a to-be-charged function, so that the communication partner device 9 can inform the personal computer 1 of the fact that the communication partner device 9 itself is a device with a to-be-charged function. That is, the personal computer 1 does not have to store the database 24 about devices each having a to-be-charged function.

FIG. 6 is a second exemplary flow chart showing the procedure of the power supplying operation of the personal computer 1 according to the embodiment. Steps up to S12 are the same as those in the first example, so that description thereof will be omitted. When the device identification portion 25 determines that the communication partner device 9 is recognized (Yes in Step S12), determination is then made as to whether a signal about a to-be-charged function is received from the communication partner device 9 or not (Step S23). The signal about a to-be-charged function is a signal which indicates that the communication partner device 9 is a device with a to-be-charged function and which indicates a minimum wattage W2 required for charging the communication partner device 9.

When determination results in that the signal indicating that the communication partner device 9 is a device with a to-be-charged function is not received (No in Step S23), Step S23 is repeated continuously till determination results in that the signal is received. On the contrary, when determination results in that the signal indicating that the communication partner device 9 is a device with a to-be-charged function is received (Yes in Step S23), the power supplying wattage determination portion 26 then determines whether or not the minimum wattage W2 required for charging the communication partner device 9 and included in the received signal is not higher than the wattage W1 allowed to be fed by the personal computer 1 (Step S24).

When determination results in that the minimum wattage W2 required for charging the communication partner device 9 is higher than the wattage W1 allowed to be fed by the personal computer 1 (No in Step S24), the procedure is ended. On the contrary, when determination results in that the minimum wattage W2 is not higher than the wattage W1 (Yes in Step S24), the procedure moves to the aforementioned Step S15.

According to the second example configured thus, it is not necessary to store information about the communication partner device 9 in the database 24 or the like. Thus, the power supplying operation can be controlled for more kinds of devices. That is, when a function of sending out a signal about a to-be-charged function is provided in the communication partner device 9, information about a to-be-charged function can be acquired from a new kind of device etc. without the necessity of updating the database 24. In addition, whether power supplying to the communication partner device is required or not is determined through wireless communication, so that power required to be fed from the battery 20 or the AC adaptor 21 does not have to be always supplied to the first power supplying module 23. Thus, power saving can be attained in the same manner as in the first example.

In the embodiment, whether to supply power to the communication partner device 9 or not may be set by a user in accordance with the power supply for driving the personal computer 1. That is, when the personal computer 1 is driven by the battery 20, the user may perform setting to prevent the power from being fed to the communication partner device 9 even if the communication partner device 9 is not in a full charge state.

Incidentally, the invention is not limited to the aforementioned embodiment and examples per se and constituent members may be modified for embodying the invention without departing from the gist of the invention in a practical stage. Constituent members disclosed in the aforementioned embodiment and examples may be combined suitably to form various inventions. For example, some of all constituent members disclosed in the embodiment and examples may be removed. In addition, constituent members disclosed in different embodiments or examples may be combined suitably.

What is claimed is:

1. An information processing apparatus configured to supply power to a communication partner device, comprising:
a communication module configured to communicate with the communication partner device;
a power supply configured to supply power to the communication partner device from a drive power source for the information processing apparatus;
a power supply determination module configured to determine whether the power supply is configured to supply power; and
a device identification module configured to determine whether the communication partner device is configured to receive power from the power supply, based on the communication by the communication module,
wherein the power supply determination module is configured to drive the power supply with the drive power source for the information processing apparatus if the device identification module determines that the communication partner device is configured to receive the power from the power supply, while the power supply determination module is not configured to drive the power supply if the device identification module determines that the communication partner device does not comprise a module to receive the power from the power supply.

2. The apparatus of claim 1, wherein the power supply determination module is configured to determine whether a charge state of the communication partner device is a full charge state, and
wherein the power supply is configured to supply power to the communication partner device if the power supply determination module determines that the charge state is not a full charge state, while the power supplying module is not configured to supply power to the communication partner device if the power supplying determination module determines that the charge state is a full charge state.

3. The apparatus of claim 2 further comprising:
a storage module configured to store a first wattage to be fed to the communication partner device by the power supply,
wherein the communication module is configured to receive information indicating a second wattage for charging the communication partner device, from the communication partner device,
wherein the power supply determination module is configured to determine whether the second wattage is higher than the first wattage, and
wherein the power supply is configured to supply power to the communication partner device if the power supplying determination module determines that the second wattage is not higher than the first wattage.

4. The apparatus of claim 2 further comprising:
a storage module configured to store a first identifier unique to each external device configured to receive the power, a first wattage to be fed to the communication partner device by the power supply, and a second wattage for charging each the external device configured to receive the power,
wherein the power supply determination module is configured to determine whether a second identifier indicating the communication partner device corresponds with the first identifier in the storage module, and configured to determine whether the second wattage is higher than the first wattage if the power supplying determination module determines that the second identifier corresponds with the first identifier, and
wherein the power supply is configured to supply power to the communication partner device when the second wattage is not higher than the first wattage.

5. The apparatus of claim 3, wherein the communication module is configured to communicate in a plurality of kinds of communication methods, and at least one of the communication methods is configured to start communication without power supply.

6. The apparatus of claim 4, wherein the communication module is configured to communicate in a plurality of kinds of communication methods, and at least one of the communication methods is configured to start communication without power supply.

7. The apparatus of claim 5, wherein the power supply determination module is configured to determine whether the information processing apparatus is driven by a battery, and
wherein the power supply module is not configured to supply power to the communication partner device when the charge state of the communication partner device is not a full charge state if the power supply determination module determines that the information processing apparatus is driven by the battery.

8. The apparatus of claim 6, wherein the power supplying determination module is configured to determine whether the information processing apparatus is driven by a battery, and
wherein the power supply module is not configured to supply power to the communication partner device when the charge state of the communication partner device is not a full charge state if the power supply determination module determines that the information processing apparatus is driven by the battery.

9. A power supply control method for supplying power to a communication partner device from a power supply in an information processing apparatus, the method comprising:
communicating with the communication partner device;
determining whether the communication partner device is configured to receive the power from the power supply;
supplying power to the power supply from a drive power source for the information processing apparatus when determining that the communication partner device is configured to receive the power from the power supply; and
supplying no power to the power supply from the drive power source when determining that the communication partner device does not have a to-be-charged function.

10. The method of claim 9 further comprising:
determining whether a charge state of the communication partner device is a full charge state when determining that the communication partner device is configured to receive the power from the power supply;
supplying power to the communication partner device from the power supply when the charge state of the communication partner device is not a full charge state; and
supplying no power to the communication partner device from the power supply when the charge state of the communication partner device is a full charge state.

11. The method of claim 10 further comprising:
storing a first wattage to be fed to an external device when power is supplied from the power supply;
receiving information indicating a second wattage for charging the communication partner device, from the communication partner device;
determining whether the second wattage is higher than the first wattage; and
supplying power to the communication partner device when determining that the second wattage is not higher than the first wattage.

12. The method of claim 10 further comprising:
storing a first wattage to be fed to the communication partner device from the information processing apparatus, a first identifier unique to each external device configured to receive the power, and a second wattage for charging each external device configured to receive the power;
determining whether a second identifier indicating the communication partner device corresponds with the first identifier;
determining whether the second wattage is higher than the first wattage when determining that the second identifier corresponds with the first identifier; and
supplying power to the communication partner device when determining that the second wattage is not higher than the first wattage.

13. The method of claim 11, wherein communication with the communication partner device is in a plurality of kinds of communication methods, and
wherein at least one of the communication methods is configured to start communication without power supply.

14. The method of claim 12, wherein communication with the communication partner device is in a plurality of kinds of communication methods, and
wherein at least one of the communication methods is configured to start communication without power supply.

15. The method of claim 13 further comprising:
determining whether the information processing apparatus is driven by a battery; and
supplying no power to the communication partner device when the charge state of the communication partner device is not a full charge state in a case of determining that the information processing apparatus is driven by the battery.

16. The method of claim 14 further comprising:
determining whether the information processing apparatus is driven by a battery; and
supplying no power to the communication partner device when the charge state of the communication partner device is not a full charge state in a case of determining that the information processing apparatus is driven by the battery.
